(19) United States
(12) Patent Application Publication
(10) Pub. No.: US 2015/0365800 A1
(43) Pub. Date: Dec. 17, 2015

(54) Determining Response Similarity Neighborhoods

(71) Applicant: Hewlett-Packard Development Company, L.P., Houston, TX (US)

(72) Inventors: Ravigopal VENNELAKANTI, Palo Alto, CA (US); Alexander Singh ALVARADO, Palo Alto, CA (US); Sastry DHULIPALA, Palo Alto, CA (US)

(21) Appl. No.: 14/763,640

(22) PCT Filed: Jan. 30, 2013
(86) PCT No.: PCT/US2013/023903

§ 371 Date: Jul. 27, 2015

(51) Int. Cl. H04W 4/02; H04L 29/08; H04W 56/00

(52) U.S. Cl. CPC H04W 4/023; H04W 56/005; H04L 67/12; H04W 84/18

(57) ABSTRACT

A method of determining response similarity neighborhoods comprises extracting data and spatial locations from a number of nodes, and with a processor, time aligning data traces, computing a feature vector of the extracted data, defining a neighborhood of the nodes, and determining similarities between a target node and a number of neighbor nodes within the neighborhood of the target node.

### BACKGROUND

In engineering nodal systems, data is received by a processing device from a number of sensor devices on a continual, periodic basis. The sensor devices may be distributed through a wide area in groups of sensor arrays, and used to detect parameters of interest in order to provide information to a user about the environment in which the sensor devices are deployed. The output of a sensor device may be sampled on a periodic basis and written to a cache of the processing device, where the processing device can then access and manage the data according to a particular application.

In some instances, erroneous measurements may be detected and recorded by a number of the sensors within the sensor arrays. In these instances, measurements are repeated to capture and maintain data quality. Alternatively, the errors in sensor recordings are identified in order to eliminate the effects of the erroneous data during processing of the data.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a sensing system, according to one example of the principles described herein.

FIG. 2 is a diagram of a spatio-temporal analytic device of the sensing system of FIG. 1, according to one example of the principles described herein.

FIG. 3 is a flowchart showing a method of determining similarities among nodes within a neighborhood, according to one example of the principles described herein.

FIG. 4 is a diagram of sensor neighborhoods of a number of sensors, according to one example of the principles described herein.

FIG. 5 is a diagram of a spatio-temporal aggregation of RMS/Peak over a Δt time period of raw responses, according to one example of the principles described herein.

FIG. 6 is a block diagram of a similarity map of a number of sensors, according to one example of the principles described herein.

Throughout the drawings, identical reference numbers designate similar, but not necessarily identical, elements.

### DETAILED DESCRIPTION

As described above, errors in data obtained via a number of sensors in a sensor array will reduce the processing quality and cause the sensor system to produce inaccurate results, or, in some instances, render the obtained data useless. This results in a significant financial burden on the individuals and entities contracted to perform the survey. For example, the financial costs related to imaging using accelerometers might be on the order of the millions of dollars. Further, quality of the data, including its accuracy and precision is important in applications such as oil and gas exploration.

In order to reduce the probability of failure in the sensor array and processing of erroneous measurements, quality checks may be integrated at the different stages of the system process. This may reduce or eliminate erroneous data from sensor measurements from being received or utilized in later possessing, confirm the process is working appropriately, and ensure that the quality of the obtained data meets a customers specifications. Quality checks also provide prompts to an administrator so that the administrator can provide further information. For example, the system, employing the quality checks, may send out an alarm indicating that a number of the sensors may be detecting and recording erroneous data due to high winds blowing across the sensors. In this example, the administrator can note this piece of information for use during post-detection processing of data obtained from the sensors.

A number of logistic and engineering challenges may be associated with these systems. This may be especially true when attempting to monitor the vast amounts of data received from the sensors within the sensor array. For example, a mega-channel system may utilize on the order of approximately one million nodes spread across an area of 1,500 to 3,000 square miles. The sensors within the sensor array are subject to a number of noise sources which contaminate and distort the recordings. These noise sources include, for example, the effects nearby roads, trains, communities, oil rigs, wandering animals, wind, and many other noise sources.

The sensors of the present disclosure are nodal, run on limited battery power, are wirelessly connected to a command center, processing center, or other data processing venue, and are subject to a number of malfunctioning scenarios. Malfunctioning scenarios may include deployment errors, such as lose ground to sensor coupling, wide orientation, and tilt. Other malfunctioning scenarios may foe due to high environmental temperatures, low battery power, or electromagnetic interferences, among others. Still further, human activity, wandering animals, rain, and wind may also contaminate and distort the data recorded by the sensors.

Thus, erroneous data acquisition from the sensors forces the surveying entity to repeat the acquisition process, or may cause the sensor system to fail to detect and process what the sensor system is intended to detect and process such as, for example, data associated with potential oil or gas reserves in the ground. As compared with wired sensors, wireless sensors may be more difficult to monitor for errors. This may be compounded when a large number of sensors such as approximately one million are deployed across a very large acreage as proposed herein.

In order to reduce or eliminate the probability of utilizing erroneous or anomalous data in later processing, quality checks may be integrated at the different stages of the system processes. This ensures the system is working appropriately and the quality of data meets desired specifications. One approach in quality checks is to discern anomalous behaviors in acquisition system components, and redress or take appropriate remedial actions if anomalous behavior is detected.

The present disclosure, therefore, describes a method of determining response similarity neighborhoods. The method comprises extracting data and spatial locations from a number of nodes, and with a processor, time aligning data traces, computing a feature vector of the extracted data, defining a neighborhood of the nodes, and determining similarities between a target node and a number of neighbor nodes within the neighborhood of the target node.

The present disclosure further describes a spatio-temporal analytic device for determining similarities among nodes within a neighborhood. The spatio-temporal analytic device comprises a processor to extract data from a number of sensors within a sensor array, and a data storage device coupled to the processor. The data storage device comprises a time alignment module to time align a number of data traces, a feature vector module to compute a feature vector of the data extracted from a number of nodes, a spatial context module to extract spatial location data from the data extracted from a number of nodes, and a similarity check module to determine similarities between a target node and a number of neighbor nodes within the neighborhood of the target node.

Still further, the present disclosure describes a computer program product for determining similarities among nodes within a neighborhood. The computer program product comprises a computer readable storage medium comprising computer usable program code embodied therewith. The computer usable program code comprises computer usable program code to, when executed by a processor, extract raw data from a number of nodes, computer usable program code to, when executed by a processor, time align a number of data traces, computer usable program code to, when executed by a processor, extract spatial location data from the raw data extracted from a number of nodes, computer usable program code to, when executed by a processor, compute a feature vector of the data extracted from a number of nodes, and computer usable program code to, when executed by a processor, determine similarities between a target node and a number of neighbor nodes within the neighborhood of the target node.

As used in the present specification and in the appended claims, the terms “sensor,” “node,” or similar terms are meant to be understood broadly as any device used to detect a number of environmental or physical quantities, and convert it into a signal which can be interpreted by a computing device. In one example, the sensors are high resolution Richter sensor nodes (RSNs) developed and sold by Hewlett-Packard Company. The Richter sensors are cost-effective, accurate, and high-end inertial measurement units (IMUs) capable of measuring movement on the x-, y-, and z-axis, as well as pitch, roll and yaw, all on a single, homogenous planar chip. Richter sensors provide these six axis of sensing while overcoming the inherent orthogonal inaccuracy produced by other IMUs. In addition to the devices used to detect movement, an RSN comprises a number of additional computing devices that compute and store data associated with the detected movement. Further, the RSNs communicate wirelessly through, for example, wireless fidelity (Wi-Fi) communications modules. Thus, the RSNs comprise elements built around a sensor device that capture, process, store, and transmit the data collected from the sensor device.

Even still further, as used in the present specification and in the appended claims, the term “a number of” or similar language is meant to be understood broadly as any positive number comprising 1 to infinity; with zero indicating the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

Further, in the following description, the example of a number of sensor devices distributed on land within a wide area is presented in order to provide a thorough understanding of the present systems and methods. However, any distributed sensor system deployed in any environment may be used in connection with the systems and methods for determining similarities among nodes within a neighborhood described herein. The sensor devices that make up the distributed sensor system may be any type of sensor that may gather any type of data associated with the environment in which the sensor devices are deployed. The sensors of the present specification may be any data producing device or other apparatus or system that provides a measurement or digital data to a receiving device. The data producing device may transmit the data directly to the receiving device; provide the data at a node that is sampled by the receiving device, or a combination thereof. The data may include an analog measurement, a digital sequence of bits, or a combination thereof.

These distributed sensor systems may be utilized in any context. For example, the sensors and the systems of the present application may be deployed in the health care industry. In this example, the sensors may be deployed to sense and monitor a number of vital signs of a number of health care patients. Another example in which the present systems and methods may be deployed includes monitoring of infrastructure such as roads, bridges, water supplies, sewers, electrical grids, and telecommunications among others. Still another example may be the monitoring of various components of a vehicle such as an airplane. Still another example In which the present systems and methods may be deployed comprises the monitoring of brainwaves. Thus, although the presented systems and methods have application in almost any area of data acquisition and analysis, the present disclosure will describe these systems and methods in the context of a number of sensor devices distributed on land within a wide area.

Throughout the present disclosure, various computing elements and devices are used in connection with the collection, analysis, and visualization of large amounts of data obtained from a distributed sensor array. To achieve its desired functionality, the system comprises various hardware components. Among these hardware components may be a number of sensors, a number of processing devices, a number of data storage devices, a number of peripheral device adapters, and a number of network adapters, among other types of computing devices. In one example, these hardware components may be interconnected through the use of a number of busses and/or network connections, in another example, the hardware components may make up a single overall computing device or system. In still another example, the hardware components may be distributed among a number of computing devices that are interconnected through the use of a number of busses and/or network connections.

The present systems described herein may comprise a number of computer processing devices. The computer processing devices may include the hardware architecture to retrieve executable code from a data storage device and execute the executable code. The executable code may, when executed by the computer processing devices, cause the computer processing devices to implement at least the functionality of receiving and processing a number of data streams obtained from a deployed sensor array, according to the methods of the present specification described herein. In the course of executing code, the computer processing devices may receive Input from and provide output to a number of the remaining hardware units.

The data storage devices described herein may store data such as executable program code that is executed by the computer processing devices. As will be discussed, the data storage devices may specifically store a number of applications that the computer processing devices execute to implement at least the functionality described above.

The data storage devices may include various types of memory modules, including volatile and nonvolatile memory. For example, the data storage devices may include Random Access Memory (RAM), Read Only Memory (ROM), and Hard Disk Drive (HDD) memory. Many other types of memory may also be utilized, and the present specification contemplates the use of many varying type(s) of memory in the data storage devices as may suit a particular application of the principles described herein. In certain examples, different types of memory in the data storage devices may be used for different data storage needs. For example, in certain examples the computer processing devices may boot from Read Only Memory (ROM), maintain nonvolatile storage in the Hard Disk Drive (HDD) memory, and execute program code stored in Random Access Memory (RAM).

The data storage devices described herein may comprise a computer readable storage medium. For example, the data storage devices may be, but are not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. In another example, a computer readable storage medium may be any non-transitory medium that can contain, or store a program for use by or in connection with an instruction execution system, apparatus, or device.

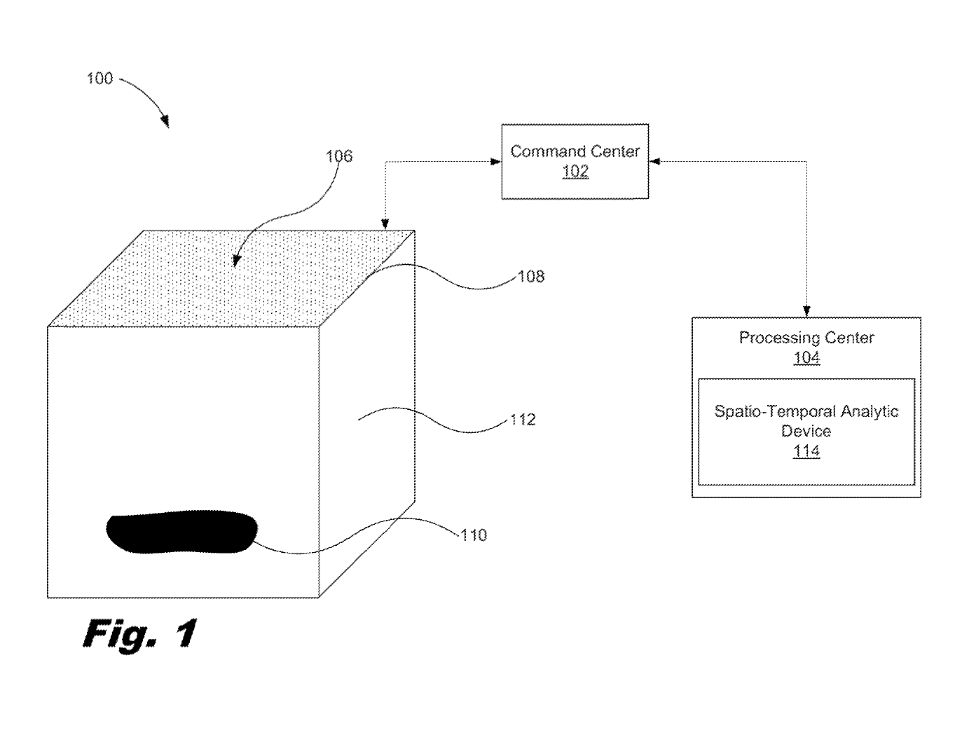

Turning now to the figures, FIG. 1 is a diagram of a sensing system (100), according to one example of the principles described herein. The sensing system (100) comprises a command center (102), a processing center (104), and an array of sensors (108) distributed within a target area (108). In one example, the sensing system (100) is used to detect the presence of a desired resource (110) such as oil or gas within the geological features in which the sensing system (100) is deployed.

The command center (102) may be located relatively closer to the target area (108) than the processing center (104), and the computing devices within the command center (102) are used to monitor daily activities performed at the target area (108) and process data representing the environmental information detected and transmitted by the sensor array (106), as will be described in more detail below, in one example, the command center does not process the data in its entirety, but, instead, monitors the data as it is received in order to, for example, ensure the quality, accuracy, and precision of the received data is appropriate.

The processing center (104) may be located relatively farther from the target area (108) than the command center (102). The processing center (104) also comprises a number of computing devices that, among other activities, process the data representing the environmental information detected and transmitted by the sensor array (106), and produce useful domain information. This information may include, for example, raw data regarding the environmental information defected in the form of, for example, stacked data sets. This information may further include information regarding the location of the desired resource (110) within the subterranean area (112), and potential paths to obtain the resource (110), among others. In one example, the command center (102) and the processing center (104) may receive data from the sensor array (108) individually. In this example, the command center (102) and the processing center (104) can process the data exclusive of each other. In another example, the command center (102) and the processing center (104) communicate with each other regarding the data collected from the sensor array (106).

The sensor array (108) distributed within the target area (108) is used to directly or indirectly detect the resource (110). The sensor array (108) is made up of any number of sensor devices that detect any number of environmental or physical parameters, and convert these parameters into a signal which can be interpreted by a computing device. In one example, the sensor array (106) comprises any number of sensors. In another example, the number of sensors within the sensor array (106) is between one and one million sensors. In still another example, the sensor array (106) comprises approximately one million sensors, in the example of approximately one million sensors, the sensors may be uniformly or non-uniformly distributed throughout the target area (108). In one example, the approximately one million sensors are distributed uniformly within the target area (108) in an approximately grid manner by dividing the target area (108) into enough subsections to provide approximately one million vertices within the target area (108) at which the approximately one million sensors are placed.

In one example, the target area (108) has an area of approximately 1,600 square kilometers, and the approximately one million sensors are spread over the 1,600 square kilometer area. Operating and supporting such a big acquisition system is an unprecedented task. As will be described in more detail below, the technical approach reflects a focus on real time analytics. There are challenges associated with field operations. The present systems and methods do not provide for the determining of similarities among nodes within a neighborhood within mega-channel sensor systems.

Data received from the sensor array (106) may be structured data, unstructured data, or a combination thereof. Further, the data received from the sensor array (106) may be historical data, real-time data, or a combination thereof. Even still further, the data received from the sensor array (106) may be any combination of structured data, unstructured data, historical data, or real-time data.

In one example, the sensors within the sensor array (106) are analog sensors, digital sensors, or a combination thereof. The individual sensors within the sensor array (106) may measure a variety of parameters of system operation states. In one example, velocities or accelerations may be detected by the sensors. In another example, pressure, temperature, flow, positions, velocities, accelerations, or a combination thereof may be detected by the sensors.

In another example, the individual sensors within the sensor array (106) may measure the same parameters in multidimensional space ordinates such as accelerometers that measure acceleration in x-, y-, and z-axis, or process state parameters such as, for example, pressure, for different components of a system. In one example, the accelerometer is a microelectromechanical systems (MEMS) based accelerometer. In another example, the sensor may be calibrated to measure other system state parameters. In still another example, the individual sensors within the sensor array (106) may be gravity gradiometers that are pairs of accelerometers extended over a region of space used to defect gradients in the proper accelerations of frames of references associated with those points. In yet another example, the individual sensors within the sensor array (106) may be any other type of sensing device used to detect any other environmental parameter, or combinations of the above examples as well as other types of sensors.

In order to satisfy the time and resource challenges presented in acquiring data from the sensors of the sensor array, the proposed systems and methods take advantage of the spatial distribution of the sensors and their relation to the temporal data traces collected. Since a number of sensors co-located in a particular neighborhood are subject to similar inputs or excitations, individual physical and behavioral neighborhoods are considered related and characterized in the present disclosure, where as present systems and methods search for potentially erroneous data acquisition by linear scan of the sensors. The present systems and methods consider shapes of these neighborhoods as being indicative of the type of perturbation and apply comparative analytics to detect anomalies, which may then be reported to an administrator for further consideration.

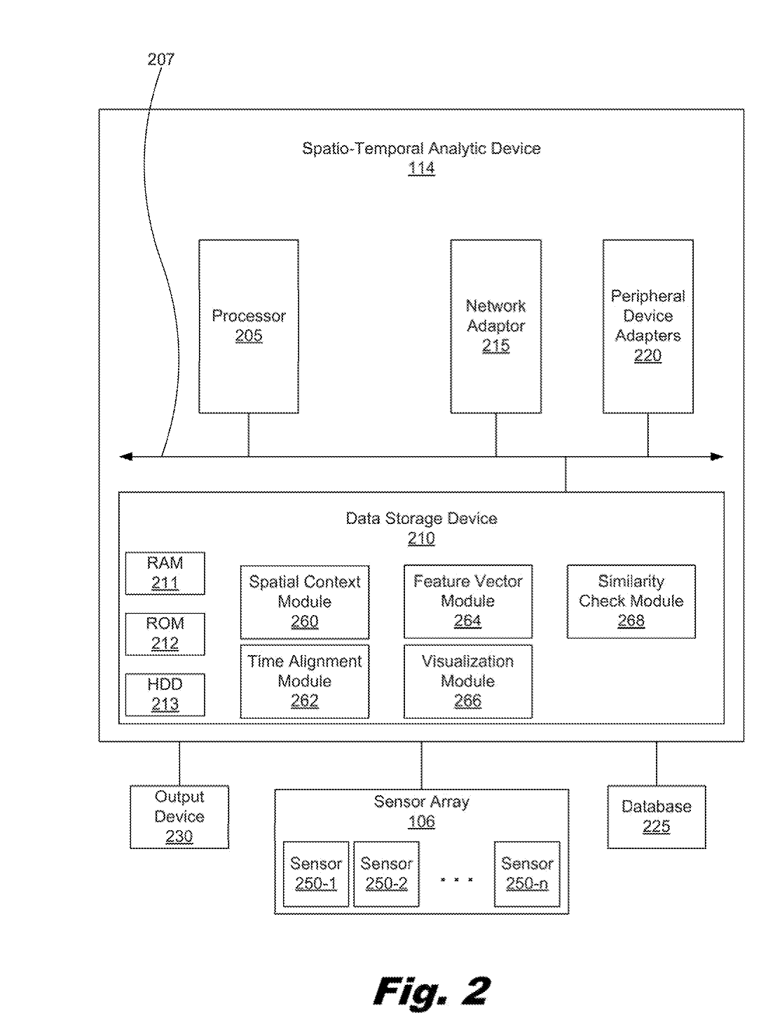

In one example, the administrator may, through the notification and visualization of this information, determine that a number of the sensors within the sensor array (106) are collecting anomalous or erroneous data. Thus, the administrator can fix the issue by, for example, fixing or replacing a number of the sensors within the sensor array (106) that are identified as acquiring erroneous or anomalous data. In another example, the data associated with the detected anomalies may be disregarded in any future processing of the data The sensing system (100) further comprises a spatio-temporal analytic device (114). The spatio-temporal analytic device (114) may be located at the command center (102) or the processing center (104). The spatio-temporal analytic device (114) of FIG. 1 will now be described in more detail in connection with FIG. 2. FIG. 2 is a diagram of the spatio-temporal analytic device (114) of the sensing system of FIG. 1, according to one example of the principles described herein. The spatio-temporal analytic device (114) comprises a processor (205), a data storage device (210), a network adaptor (215), and a number of peripheral device adaptors (220). These elements are communicatively coupled by bus (207).

The data storage device (210) comprises RAM (211), ROM (212), and HDD (213). A number of software modules are stored in the data storage device (210) to, when executed by the processor (205), bring about the functionality of the spatio-temporal analytic device (114). Specifically, the data storage device (210) comprises a spatial context module (260), a time alignment module (262), a feature vector module (264), a visualization module (266), and a similarity check module (268). These modules will be described in more detail below.

The spatio-temporal analytic device (114) is communicatively coupled to the sensor array (106) that is deployed in the target area (108). The sensor array (106) comprises a number of sensors (250-1, 250-2, 250-n). Although three sensors (250-1, 250-2, 250-n) are depicted in the sensor array (106) of FIG. 2, any number of sensors (250-1, 250-2, 250-n) may be present within the sensor array (106). As described above, approximately one million sensors (250-1, 250-2, 250-n) may be included within the sensor array (106). The sensors (250-1, 250-2, 250-n) provide the data to the spatio-temporal analytic device (114) for processing as will be described in more detail below.

The spatio-temporal analytic device (114) further comprises an output device (230). The output device (230) is any output device that provides an administrator with information processed by the spatio-temporal analytic device (114), and may comprise, for example, a display device, a printing device, or combinations thereof. A database (225) may be communicatively coupled to the spatio-temporal analytic device (114). The database (225) stores unprocessed (raw) data and processed data as will be described in more detail below.

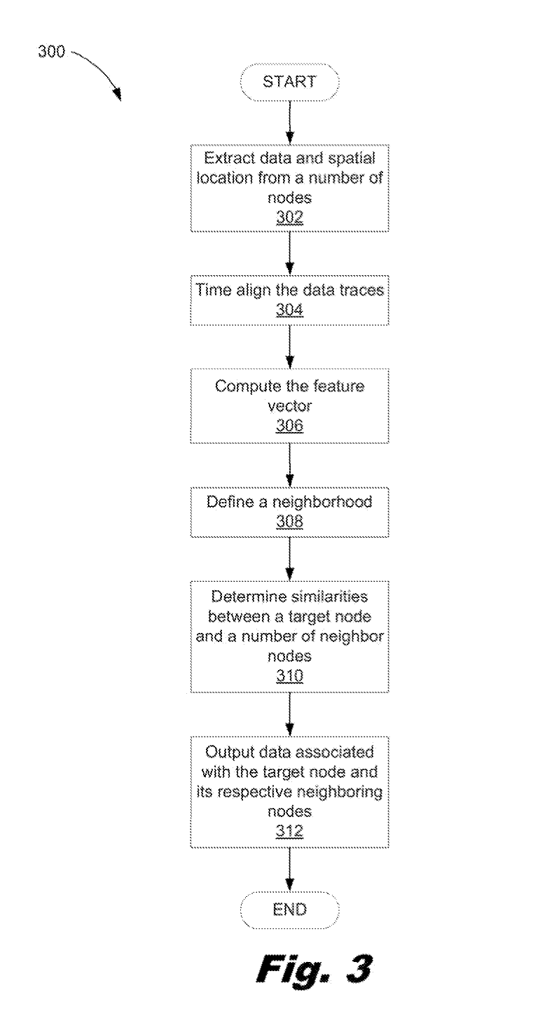

With this background, FIG. 3 is a flowchart showing a method (300) of determining similarities among nodes within a neighborhood, according to one example of the principles described herein. The method (300) may begin by extracting (block 302), with the processor, data and the spatial locations from a number of sensors (250-1, 250-2, 250-n) that have been deployed and that have detected a number of parameters of the environment in which they were deployed. The processor, executing the spatial context module (260), may extract (block 302) the spatial locations of the sensors (250-1, 250-2, 250-n). In the example used throughout this disclosure, the nodes are Richter sensor nodes (RSNs) that detect vibrations or other seismic movement within the subterranean area (FIG. 1, 112) of the area in which they are deployed. The data and spatial locations may be stored in a data storage device such as, for example, the data storage device (210) in the spatio-temporal analytic device (114) or the database (225).

During the data acquisition, a number of man-made excitations, inherent system generated excitations, or even natural phenomena create system state parameter variations or sensor responses in the target area (FIG. 1, 108). The excitation sources are used to create activity detectable by the sensors (250-1 250-2, 250-n). In on example, vibrations caused by a truck's vibration equipment travel into the subterranean area (FIG. 1, 112) of the land, are reflected from the various layers of the subterranean area (FIG. 1, 112), and are detected by the sensors (250-1, 250-2, 250-n) as raw reflected responses of system to excitation. In this manner, data associated with the characteristics of the subterranean area (FIG. 1, 112) can be analyzed at, for example, the processing center (FIG. 1, 104), and used to detect the resource (FIG. 1, 110) in the subterranean area (FIG. 1, 112). It is this raw data that is extracted (block 302) from the sensors (250-1, 250-2, 250-n). The data extracted (block 302) from the sensors (250-1, 250-2, 250-n) comprises data traces that comprise a record of the data that is sent and received on a communication link from each of the sensors (250-1, 250-2, 250-n) to, for example, the spatio-temporal analytic device (114) executing at the command center (102) or the processing center (104).

Further, as mentioned above, data associated with the spatial location of the sensors (250-1, 250-2, 250-n) at the time of deployment is also extracted, individual sensors (250-1, 250-2, 250-n) within the sensor array (FIG. 1, 106) are placed in known locations. In one example, the location of the sensors (250-1, 250-2, 250-n) within the target area (108) are placed using a global positioning system (GPS) to provide a more precisely known location of each of the individual sensors. The spatial location of the sensors (250-1, 250-2, 250-n) within the target area (108) is used in later processing as will be described in more detail below.

Turning again to FIG. 3, the method (300) may continue by time aligning (block 304) the data traces obtained from the extraction (block 302) by executing, with the processor (205), the time alignment module (282). Each of the sensors (250-1, 250-2, 250-n) has kept a time record while deployed in the target area (108). However, the sensors (250-1, 250-2, 250-n) defect environmental parameters and associate those records with the times at which events were detected, However, the time records of ail the sensors (250-1, 250-2, 250-n) may not be synchronized with, for example, a common time of the system (FIG. 1, 100). Therefore, the sensors (250-1, 250-2, 250-n) are time aligned (block 304) so they are all synchronized and can be temporally compared.

The processor (205), executing the feature vector module (264), computes (block 306) a feature vector for the extracted data. In one example, a feature can be based on raw sensor response data, derived statistical or algebraic formulae of response parameters, or combinations thereof. In another example, a feature can be based on any feature itself and its spatio-temporal variations that are applied recursively. Thus, feature vectors computed themselves may be considered as raw input. Though the system has access to raw data streams from the sensors (250-1, 250-2, 250-n), and this raw data may be used in the processing. In one example, the system (100) optimizes the representation by reducing each data stream to a feature vector. The features are designed to be easily computed from the raw trace data and provide sufficient information or a measure to signify a phenomena. In one example, the features are used to designate normal system operational states or any anomalous states. Examples of features that may be utilized in computing (block 306) the feature vector are listed in Table 1.

TABLE 1
Examples of Features used in feature vector computation

| Feature | Description |
|---|---|
| Root mean square | The RMS values are calculated over consecutive |
| (RMS) values | one second windows on the trace data. |
| Peak value | The peak values are calculated over consecutive |
| | one second windows on the trace data. |
| Location | Corresponds to the spatial coordinates defined by |
| | the latitude and longitude provided by the GPS. |
| Change point | Index events at which change points in the data |
| locations | traces are detected. |
| Mean and median | Calculated over consecutive one second windows |
| value | on the trace data. |
| Variance | Calculated over consecutive one second windows |
| | on the trace data. |

The features listed in Table 1 are not exhaustive, and more or less features may be used in computing a feature vector. Further, the features are dependent on the type of sensors utilized in the system (100) and the type of data those sensors collect.

The similarity tests of data trace field may be applied in two selectable ways. The first way is a spatial/temporal or feature window-based aggregation for a derived feature, and applying lower and upper bound thresholds. The second way is by determining a generic neighborhood of influence determined by both combined spatio-temporal data references and computed feature vector Euclidean distances within the limits of specified thresholds, thus conditioning the neighborhood determination on both spatial/temporal proximity and feature similarity.

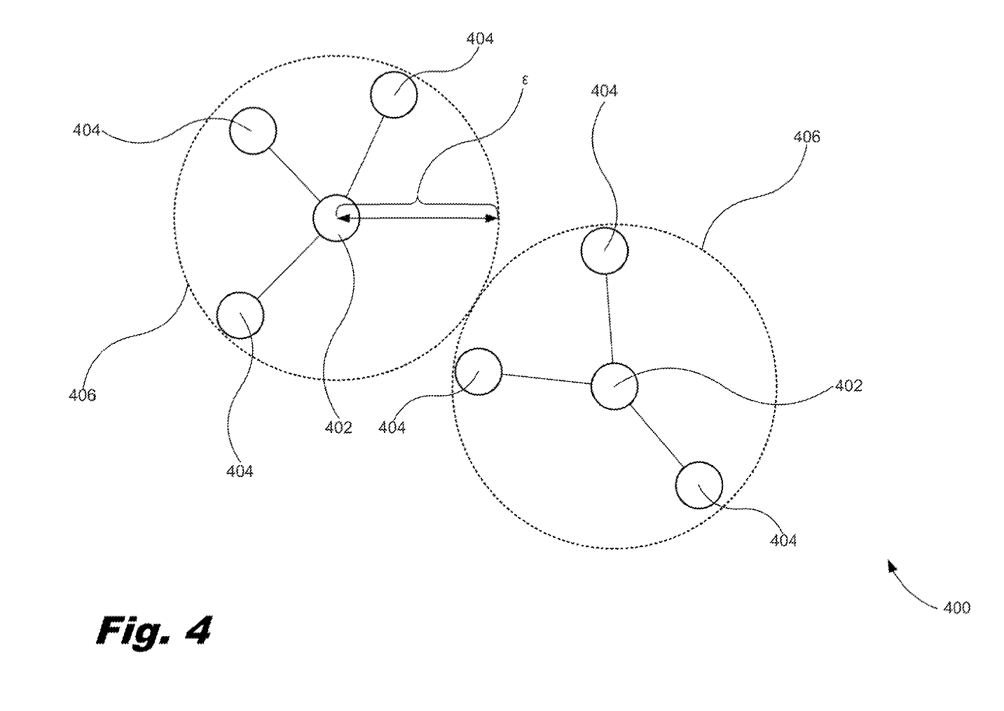

The processor (205), executing the similarity check module (268), defines (block 308) a neighborhood by determining which nodes fall within a normative distance such as, for example, an Euclidian distance from a target node. When the sensors (250-1, 250-2, 250-n) are deployed in the target area (FIG. 1, 108), each sensor (250-1,250-2, 250-n) has a number of sensors considered to be co-located in a particular neighborhood and subject to and detect similar inputs. FIG. 4 is a diagram (400) of sensor neighborhoods (406) of a number of sensors (250-1, 250-2, 250-n), according to one example of the principles described herein.

As depicted in FIG. 4, a target node (402) is a sensor (250-1, 250-2, 250-n) that is currently being analyzed in connection with neighboring sensors (250-1, 250-2, 250-n) designated as elements 404 as described herein. A neighborhood (408) is defined as any sensor (250-1, 250-2, 250-n) that is an Euclidian distance (ε) from the target node (402). To determine which neighboring sensors (404) are within the Euclidian distance (ε), and, therefore, considered as being within the neighborhood of the target node (402), the processor (205), executing the similarity check module (288), calculates the spatial/temporal or feature window-based aggregation for a derived feature, and applying lower and upper bound thresholds, or calculates a generic neighborhood of influence determined by both combined spatio-temporal data references and computed feature vector Euclidean distances within the limits of specified thresholds as described above.

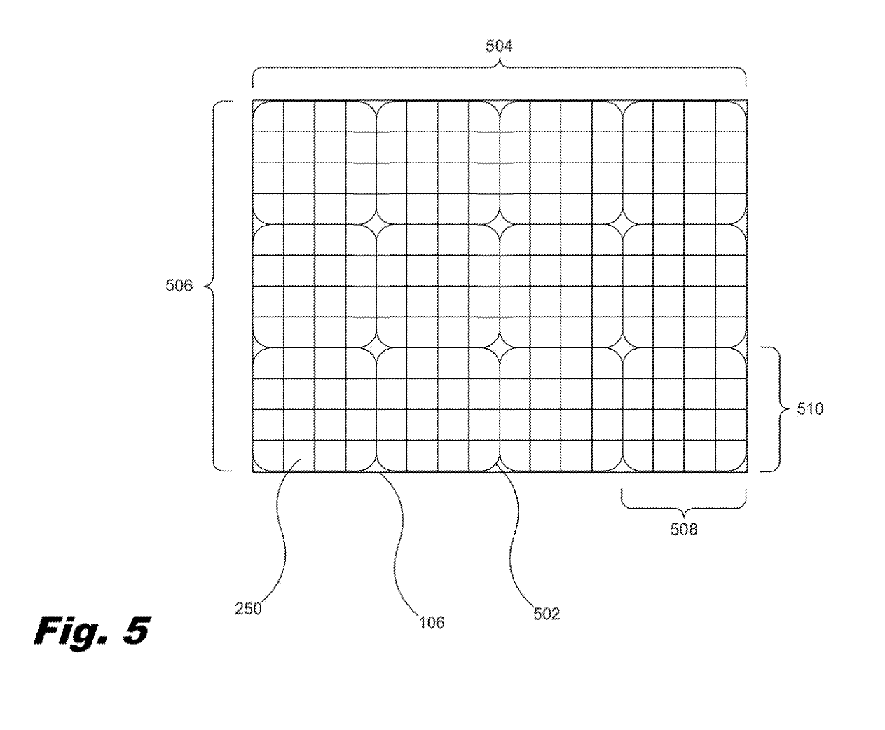

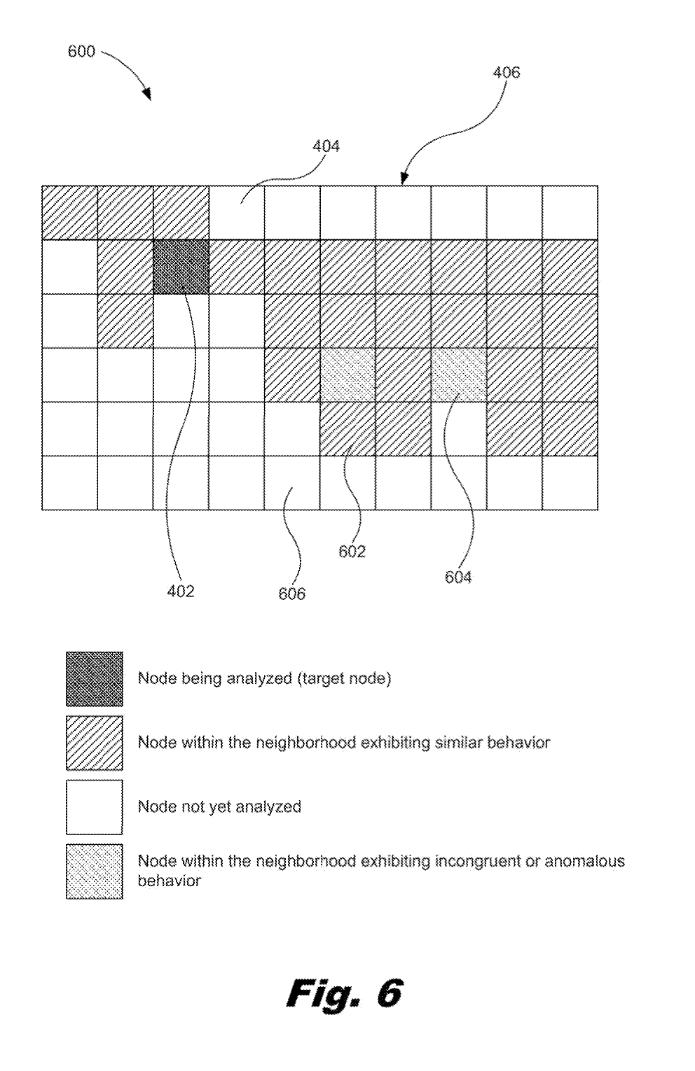

As to the first method through spatial/temporal or feature window-based aggregation for a derived feature, and applying lower and upper bound thresholds, for example, the grid of sensors (250-1, 250-2, 250-n) as positioned within the target area (FIG. 1, 108) and as determined by the spatial locations extracted from the sensors (250-1, 250-2, 250-n) at block 302 is divided into a number of cells where Analytic {rms, Peak} is computed as follows. FIG. 5 will be described hereafter in connection with the first method. FIG. 6 is a diagram of a spatio-temporal aggregation of RMS/Peak over a Δt time period of raw responses, according to one example of the principles described herein:

$$\begin{matrix}\{ {rms}_{nxytC}^{C} , {peak}_{nxytC}^{C} \} = \text{?} \{ {rms}_{i , j , t} / {n}_{MaxC} , {peak}_{ni , j , t} / {n}_{MaxC} \} \\ \text{?} \text{indicates text missing or illegible when filed} & Eq . 1 \\ \{ {x}_{nxytC}^{C} , {y}_{nxytC}^{C} \} = \text{?} \{ {x}_{i , j , t} + 0.5 {W}_{Cc} , {y}_{i , j , t} + 0.5 {L}_{Cc} , {t}_{i , j , t} + 0.5 {T}_{Cc} \} \\ \text{?} \text{indicates text missing or illegible when filed} & Eq . 2\end{matrix}$$

where, for each x_{i,j,t}, y_{i,j,t}, t_{i,j,t}

{x_{gridMin}+W_{Cc}*i<x_{i,j}<=x_{gridMin}+W_{Cc}*(i+1)} Eq. 3

{y_{gridMin}+L_{Cc}*j<x_{i,j}<=y_{gridMin}+L_{Cc}*(j+1)} Eq. 4

{t_{timewindowstart}+T_{Cc}*j<t_{i,j}<=t_{gtimewindowstart}+T_{Cc}*(j+1)} Eq. 5

with definitions:

n_{MaxC}=N_{Wc}*N_{Lc} Eq. 6

n_{xMaxC}=(x_{gridMax}−x_{gridMin})/W_{Cc} Eq. 7

n_{yMaxC}=(y_{gridMax}−y_{gridMin})/L_{Cc} Eq. 8

n_{xytC}={i+n_{xMaxC}*j} in {t_{timewindow}} Eq. 9

where N_{Wc} is the number (504) of Width-wise cells; N_{Lc} is the number (506) of Length-wise cells; W_{Cc} is the width (508) of each cell; L_{Cc} is length (510) of each cell; n is the n^{th} cell; and x, y, and t are the x and y values of the n^{th} cell at time t,
and, further, where

$$\text{?}$$

$$\text{?} \text{indicates text missing or illegible when filed}$$

designates the iteration over the entire sensor array with j and i indices for x and y dimensions, j=0 and i=0 being the bottom left sensor (250) in FIG. 6,

$$\text{?}$$

$$\text{?} \text{indicates text missing or illegible when filed}$$

designates the summation over a time window,
ncMaxC, nyMaxC indicate the number of cells (502) in the x and y dimensions, respectively, and
nxytC indicates the xy cell index at time t,
and, further, where the neighborhood characterization based on the analytic is defined as:

k_{AnomalyMin}<=r_{RmsPeak}<=k_{AnomalyMax} Eq. 10

where

$${\sum }_{j} {( 1 = 0 )}^{t} nxyC {r}_{RmsPeak} = {rms}_{nxyC}^{C} / {peak}_{nxyC}^{C} \} \qquad Eq . 11$$

As demonstrated above, the first method of similarity neighborhood generation may begin by dividing the spatial layout of the sensor array (106) into a priori decided cells of spatial regions (502). Each spatial region (502) may comprise a number of sensors (250-1, 250-2, 250-n) designated in FIG. 6 as 250 generally. A parametric feature is calculated in each of the a priori spatial regions (502), and the feature is analyzed for similarity. Thus, the spatial regions (502) remain the same across multiple time frames as time goes on. The parameter or feature variations are compared for similarity either with one another, or across multiple time frames for a space region. The above method can also be applied with a priori selected time windows. The above first method of similarity neighborhood generation utilizes a priori fixing of either the spatial or temporal regions, and determines feature behavioral similarities.

As to the second method through determining a generic neighborhood of influence determined by both combined spatio-temporal data references and computed feature vector Euclidean distances within the limits of specified thresholds the Euclidian distance (ε) is determined, for example, as follows:

ε=A\sqrt{2} Eq. 12

where A is the distance between the nodes on a Cartesian grid. The processor (205), executing the similarity check module (268), calculates the Euclidean distance between two ‘N’ dimensional vectors ‘x’ and ‘y,’ which is given by:

∥x−y∥₂ Eq. 13

where the L₂ norm is defined as:

∥x∥₂=\sqrt{x^{T}x} Eq. 14

For the selected nodes which also have an estimated feature vector, the processor (205), executing the similarity check module (268) calculates the Euclidean norm. The processor (205), executing the similarity check module (268) also calculates the Euclidean distance as described above in connection with first method (i.e., through spatial/temporal or feature window-based aggregation for a derived feature, and applying lower and upper bound thresholds) between the feature vectors from the target node (402) and its neighbor nodes (404). The spatio-temporal analytic device (114) considers the nodes which have 80% or more neighboring nodes whose feature distance is less than the threshold “Th.” The confidence can be increased or decreased by varying the threshold based on field data.

The processor (205), executing the similarity check module (268), computes the cardinality of the neighborhood of influence conditioned on both spatial proximity and feature similarity. Therefore, for each analyzed target node (402), there exists an associated list of neighbor nodes (404) that satisfy the imposed constraints. The cardinality of Influence is defined as the number of nodes in the neighborhood.

The similarity neighborhood is mathematically decided by a normative such as, for example, an Euclidian multi-dimensional envelope grouping. When the above second method is utilized across multiple time frames, with spatial dimensions, and feature thresholds, it will result in different spatial regions of the feature behavioral similarity. In one example, if time is also considered as one of the dimensions in determining the envelope, it will result in spatio-temporal regions of feature similar values. In another example, application considering time, but ignoring spatial dimensions, will result in spatial regions having similar feature variation across multiple time frames. The above second method of similarity neighborhood generation is more general and complete as compared to the above first method. Further, in the above second method, the shapes of similarity neighborhoods may not be regular or may not contain the same number of sensors, and the sensors can also change across multiple time-windows as time goes by.

In both of the two methods described above, the processor (205), executing the similarity check module (268), determines (block 310) similarities between a number of target nodes (402) and a number of neighbor nodes (404) associated with each individual target node (402). Thus, the spatio-temporal analytic device (114) can quickly inform an administrator whether a number of neighboring nodes (404) recorded data that is or is not incongruent or anomalous with respect to the data recorded by a target node (402). Each sensor (250-1, 250-2, 250-n) within the sensor array (106) may be analyzed as a target node (402) in the above manner.

The processor (205), executing the visualization module (266), outputs (block 312) data associated with the target nodes (402) and their respective neighboring sensors (404). In one example, each sensor (250-1, 250-2, 250-n) in the sensor array (106) is analyzed as a target node (402). Output of the data may be rendered on the output device (230) so that an administrator may have a human-readable version of the data. In one example, the data obtained through the above method may also be stored in the database (225).

The above processes assume the use of the entire trace data. However, the system can condition a data set to include segments of the data that contain information at a data gathering event called a shot time. This reduces the region of influence from the entire spread to the active patch defined as the region of nodes that receives the source input. The consistency of influence may be a threshold factor that indicates the number of traces that meet the cardinality of neighborhood of influence (CIN) for that node, and may be user definable.

FIG. 6 is a block diagram of a similarity map (600) of a number of sensors (250-1, 250-2, 250-n), according to one example of the principles described herein. When the sensors (250-1, 250-2, 250-n) are gathered in from the target area (108) after completion of recording, they are subjected to a debriefing process in which the data these sensors have obtained is extracted as described above in connection with block 302 of FIG. 3. However, the order by which the data is extracted from the sensors (250-1, 250-2, 250-n) may be different than the order in which they were deployed in the target area (108). However, using the spatial location data, the spatio-temporal analytic device (114) knows where within the target area (108) a specific sensor (250-1, 250-2, 250-n) was deployed. With this information, a map (500) may be created as data comes into the spatio-temporal analytic device (114).

As depicted in FIG. 6, a target node (402) is the node being analyzed with respect to its neighbor. A number of neighboring sensors (404) sensor neighborhoods (406) are also represented. However, some neighboring sensors (404) are classified as nodes that are exhibiting similar (602) and dissimilar (604) behavior. The nodes (606) with no fill pattern are nodes that have not yet been analyzed. In other words, the data from these nodes (606) have know locations, but have not yet been debriefed, extracted, and analyzed by the spatio-temporal analytic device (114).

In the example of FIG. 6, two nodes (604) exhibiting incongruent or anomalous behavior with respect to the target node (402) are depicted. These nodes are, therefore, identified as providing unreliable data, and may be disregarded in future processing. If, in some instances, too many of these incongruent nodes (604) are detected, an administrator may determine that the survey project may have to be performed again. This means that the sensors (250-1, 250-2, 250-n) are redeployed in the target area (108) and data is capture again. However, the time it takes for the present systems and methods to perform the above analysis to determine if there exists such incongruent nodes (604) is far less than the time it would take to completely process the data obtained there from. For example, the present systems and methods inform an administrator of incongruent nodes (604) in real time or within hours of data acquisition. In contrast, it may take 20 days or more for the nodes to be completely analyzed and processed. Thus, the present systems and methods provide earlier detection of anomalous data captured by the sensor array (106).

Thus, the spatio-temporal analytic device (114) outputs visualizations depicting neighborhood pattern variations in relation to the CIN metric and Euclidian distance metric. Further, the spatio-temporal analytic device (114) outputs a neighborhood characterization based on spatial distribution of the sensors (250-1, 250-2, 250-n) and variability In relation to time (e.g., shot events). Thus, the present systems and methods rely on the analysis of spatio-temporal features of a sensor (250-1, 250-2, 250-n) to profile incongruent neighbors of that sensor.

As described above, a number of logistic and engineering challenges are associated with the nodal systems comprising a number of sensors. This may be especially true when trying to monitor large deployments of the sensors, and processing vast amounts of data stored on each node that will be retrieved later by a processing center (104). The present systems and methods consider the task of anomaly detection as discernible from node responses. There are two scenarios of quality checking by the present non-intrusive anomalous node detection method from response data: (1) as applied on-line during data acquisition, and (2) while debriefing recorded data from retrieved nodes. Both the scenarios are different and are subject to special processing specific to individual scenario. The present disclosure discusses the scenario during debriefing of retrieved nodes. However, in either of the above scenarios, the constraints are time (decisions within 20 seconds) or memory scale related (80 Tera Bytes per day or more). Hence, the present systems and methods provide for a real time efficient validation of the node behavior, specifically related to trace data recordings.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (205) of the spatio-temporal analytic device (114) or other programmable data processing apparatus, implement the functions or acts specified in the flowchart and/or block diagram block or blocks. In one example, the computer usable program code may be embodied within a computer readable storage medium; the computer readable storage medium being part of the computer program product.

The specification and figures describe systems and methods of determining response similarity neighborhoods. The systems and methods comprise extracting data and spatial locations from a number of nodes, and with a processor, time aligning data traces, computing a feature vector of the extracted data, defining a neighborhood of the nodes, and determining similarities between a target node and a number of neighbor nodes within the neighborhood of the target node. These systems and method may have a number of advantages, including: (1) faster assessment of the existence of anomalous sensors within a survey: (2) computationally Inexpensive; and (3) reduces or eliminates erroneous data resulting from a malfunctioning sensor from being processed as bona fide data, among other advantages.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of determining response similarity neighborhoods comprising:
extracting data and spatial locations from a number of nodes; and
with a processor:
time aligning data traces;
computing a feature vector of the extracted data;
defining a neighborhood of the nodes; and
determining similarities between a target node and a number of neighbor nodes within the neighborhood of the target node.

2. The method of claim 1, further comprising determining similarities between a number of neighborhoods identified across a number of spatio-temporal dimensions.

3. The method of claim 1, in which defining the neighborhood of nodes comprises:
with the processor, determining which of a number of nodes within an array of nodes are within a defined normative distance from a target node; and
designating those nodes that are within the normative distance from the target node as being neighboring nodes.

4. The method of claim 1, in which determining similarities between a target node and a number of neighbor nodes within the neighborhood of the target node comprises:
spatio-temporally aggregating a number of parameters of the derived feature vector; and
applying lower and upper bound thresholds.

5. The method of claim 1, in which determining similarities between a target node and a number of neighbor nodes within the neighborhood of the target node comprises;
with the processor:
determining which of a number of nodes within an array of nodes are within a defined normative distance from a target node;
calculating a measure of the normative distance; and
determining the cardinality of the neighborhood of influence conditioned on both spatial proximity and feature similarity between the target node and the neighbor nodes.

6. The method of claim 1, further comprising outputting the determined similarities between the target node and the neighbor nodes within the neighborhood of the target node to an output device.

7. A spatio-temporal analytic device for determining similarities among nodes within a neighborhood comprising:
a processor to extract data from a number of sensors within a sensor array; and
a data storage device coupled to the processor, in which the data storage device comprises:
a time alignment module to time align a number of data traces;
a feature vector module to compute a feature vector of the data extracted from a number of nodes;
a spatial context module to extract spatial location data from the data extracted from a number of nodes; and
a similarity check module to determine similarities between a target node and a number of neighbor nodes within the neighborhood of the target node.

8. The spatio-temporal analytic device of claim 7, further comprising an output device to output the determined similarities between the target node and the neighbor nodes within the neighborhood of the target node.

9. The spatio-temporal analytic device of claim 7, in which the sensors are Richter sensor nodes.

10. The spatio-temporal analytic device of claim 7, in which the sensor array comprises approximately one million sensors.

11. A computer program product for determining similarities among nodes within a neighborhood, the computer program product comprising:
a computer readable storage medium comprising computer usable program code embodied therewith, the computer usable program code comprising:
computer usable program code to, when executed by a processor, extract raw data from a number of nodes;
computer usable program code to, when executed by a processor, time align a number of data traces;
computer usable program code to, when executed by a processor, extract spatial location data from the raw data extracted from a number of nodes;
computer usable program code to, when executed by a processor, compute a feature vector of the data extracted from a number of nodes; and
computer usable program code to, when executed by a processor, determine similarities between a target node and a number of neighbor nodes within the neighborhood of the target node.

12. The computer program product of claim 11, further comprising computer usable program code to, when executed by a processor, output the determined similarities between the target node and the neighbor nodes within the neighborhood of the target node.

13. The computer program product of claim 11, in which the computer usable program code to, when executed by a processor, determine similarities between a target node and a number of neighbor nodes within the neighborhood of the target node comprises;
computer usable program code to, when executed by a processor, spatio-temporally aggregate a number of parameters of the derived feature vector; and
computer usable program code to, when executed by a processor, apply lower and upper bound thresholds.

14. The computer program product of claim 11, in which the computer usable program code to, when executed by a processor, determine similarities between a target node and a number of neighbor nodes within the neighborhood of the target node comprises:
computer usable program code to, when executed by a processor, determine which of a number of nodes within an array of nodes are within an Euclidian distance from a target node;
computer usable program code to, when executed by a processor, calculate an Euclidian norm; and
computer usable program code to, when executed by a processor, determine the cardinality of the neighborhood of influence conditioned on spatial proximity and feature similarity between the target node and the neighbor nodes.

15. The computer program product of claim 11, further comprising;
computer usable program code to, when executed by a processor, determine which of a number of nodes within an array of nodes are within an Euclidian distance from a target node; and
computer usable program code to, when executed by a processor, designate those nodes that are within the Euclidian distance from the target node as being neighboring nodes.
